(19) United States
(12) Patent Application Publication
(10) Pub. No.: US 2015/0262801 A1
(43) Pub. Date: Sep. 17, 2015

(54) METHOD AND DEVICE FOR ANALYZING ION STRUCTURE

(71) Applicant: Beijing Institute of Technology, Beijing (CN)

(72) Inventors: Wei XU, Beijing (CN); Yi XIN, Beijing (CN); Yu CHEN, Beijing (CN); Li ZHENG, Beijing (CN); Xiang FANG, Beijing (CN)

(21) Appl. No.: 14/631,973

(22) Filed: Feb. 26, 2015

(30) Foreign Application Priority Data
Mar. 12, 2014 (CN) 201410090656.7

(51) Int. Cl. H01J 49/00; H01J 49/40

(52) U.S. Cl. CPC H01J 49/0036; H01J 49/40; H01J 49/0081

(57) ABSTRACT

The disclosure provides a device and a method for analyzing an ion structure, comprising: pre-processing a time domain signal of a mirror current of ions to be measured that are obtained from an ion mass analyzer, to obtain a signal to be measured; extracting information about a position a spectral signal of the signal to be measured through a Fourier transforming: modulating the spectral peak signal, to obtain a modulated signal; filtering the modulated signal, to obtain a filtered signal; estimating parameters of an ion motion model with respect to the filtered signal, to determine information on structural characteristics of the ions to be measured from the estimated parameters. According to the device and the method for analyzing an ion structure of the present disclosure, the ion structures may be analyzed by directly analyzing the time domain signal of the mirror current of the ion.

### CROSS REFERENCE TO RELATED APPLICATIONS

The present application claims priority under 35 U.S.C. §119 to Chinese Patent Applications No. 201410090656.7, filed on Mar. 12, 2014, the entire contents of which are incorporated herein by reference.

### TECHNICAL FIELD

The present disclosure generally relates to a method and a device for analyzing an ion structure, and more particularly, to a method and a device for analyzing an ion structure by directly analyzing time domain signals of a mirror current of ions.

### BACKGROUND

Fourier transform Mass Spectrometry (MS) is widely adopted in biochemical analysis due to its high resolution and high sensitivity. A working process of the Fourier transform Mass Spectrometry is trapping ions to be measured by an ion mass analyzer, inducing a mirror current on an electrode by motion of the excited ions, and analyzing a mass-to-charge ratio (m/z) through a spectral analysis of signals of the mirror current. Currently, Fourier Transform Ion Cyclotron Resonance Cells (FT-ICR), Orbitraps and Fourier Transform Quadrupole Ion Traps, etc. are main ion mass analyzers applied in the Fourier transform Mass Spectrometry.

Since in the above ion mass analyzers, ions with different mass-to-charge ratios have different motion characteristics, the conventional Fourier transform Mass Spectrometry can distinguish the ions of different mass-to-charge ratios by analyzing Fourier transformed spectral peaks of signals attenuated with time (hereinafter, briefly referred to as time domain signals) of different ions. However, with regard to isomers, their ions with the same charge-to-mass ratio may have different ion structures. In this case, analyzing the structures of the ions has to rely on more hardware devices or has to be performed by adopting other analyzing means.

Generally, in order to achieve both accurate qualitative and quantitative analysis of ions, in addition to charge-to-mass ratios, ion structures need to be analyzed as well. Currently, a tandem MS method and an ion mobility method are typically adopted to analyze ion structures. The tandem MS method is to apply energy to fragment the ions to be measured, and to reconstruct an ion structure by analyzing ion fragments. The ion mobility method is typically to analyze an ion structure by analyzing collision cross sections of the ions to be measured. Typically, the tandem MS method needs to be performed under high vacuum condition (<1 mTorr), and the ion mobility method is performed under high pressure conditions (>1 Torr), but has low resolution (typically less than 1000). Instruments adopted in these methods have complex structure due to the big working pressure difference, and vacuum power consumption is thus increased. Meanwhile, in these methods, ions move among a plurality of vacuum chambers, and an experimental control of the ions to be measured is stringent, thus ion loss is significant.

In 2012, Fan Yang, Jacob Voelkel and David V. Dearden proposed a method for analyzing ion structures in “Collision Cross Sectional Areas from Analysis of Fourier Transform Ion Cyclotron Resonance Line Width: A New Method for Characterizing Molecular Structure” (Anal. Chem., 2012, 84 (11), 4851-4857) analyzing collision cross sectional areas through analyzing Fourier Transform Ion Cyclotron resonance line widths. This method is to increase an internal pressure in the Fourier transform ion cyclotron resonance ion trap, so as to cause the ion-molecule collision to lead the ion mirror current attenuate. FWHMs (Full Width Half Maximum) of the spectral lines depend on speeds of the attenuation, and the faster the attenuation in time domain is, the wider the FWHM in corresponding frequency domain is. Thus, the collision cross sectional areas of ions may be calculated by measuring the FWHMs, thereby the collision cross sectional areas of ions may be obtained by analyzing the attenuation of a mirror current of the ions, to eventually obtain the structures of ions. However, as Fan Yang et al note in the paper, the method only applies to low mass system or molecular.

### SUMMARY

In order to at least partially solve the above problem, the objective of the present disclosure is to provide a method and a device for analyzing an ion structure that may analyze the ion structure by directly analyzing time domain signals of the ions to be measured from an ion mass analyzer.

According to a first aspect of the present disclosure, a method for analyzing an ion structure, including the following steps: step 1, pre-processing a time domain signal of a mirror current of ions to be measured that are obtained from an ion mass analyzer, to obtain a signal to be measured; step 2, extracting a spectral peak signal of the signal to be measured; step 3, modulating the spectral peak signal, to obtain a modulated signal; step 4, filtering the modulated signal, to obtain a filtered signal; step 5, estimating parameters of an ion motion model with respect to the filtered signal, to determine information on structural characteristics of the ions to be measured from the estimated parameters.

The pre-processing in the step 1 may further include; performing zero-padding and/or enhancement and de-noising on the signal to be measured.

The extracting in the step 2 may further include: firstly, transforming the signal to be measured into a frequency domain by a Fourier transforming; and then, adopting a positioning algorithm, to obtain the spectral peak signal.

The modulating in the step 3 may further include: estimating an initial phase ψ*ᵢ of the spectral signal; and then, modulating the spectral peak signal to a low frequency with the estimated phase ψ*ᵢ to obtain the modulated signal. Further, the estimating an initial phase ψ*ᵢ may include: randomly selecting two initial phases φ₁ and φ₂, and modulating the spectral peak signal with the random selected initial phases φ₁ and φ₂, and extracting a low frequency signal from the spectral peak signal by a low-pass filtering; then, solving a quotient K through an equation

$$\frac{cos ( {ψ}_{i} - {ϕ}_{1} )}{cos ( {ψ}_{i} - {ϕ}_{2} )} = K ;$$

and finally, solving an equation

$${ψ}_{i}^{*} = arc tan ( - \frac{cos {ϕ}_{1} - K cos {ϕ}_{2}}{sin {ϕ}_{1} - K sin {ϕ}_{2}} ) ,$$

to obtain the estimated initial phase ψ*₁.

The modulating in the step 3 may further include: modulating the spectral peak signal to an intermediate frequency, to obtain the modulated signal.

The filtering in the step 4 may further include: filtering the modulated signal by adopting an n-order m-layer filter and a normalized cutoff frequency of 0.01˜0.03, wherein n is 300-800 and m≧3; and de-sampling the signal after each order of the filterings, to adjust the range of the signal.

Before the step 4, the modulated signal may be extended, and if a point length of the extension is Num, and a number of orders of the filter is Order, then Num Order≧½Order+1.

The filtering in the step 4 may further include: filtering the modulated signal by adopting an n-order m-layer filter and a normalized cutoff frequency of 0.01˜0.03, wherein n is 300-800 and m≧3; and de-sampling the signal after each order of the filterings, to adjust the range of the signal.

The estimating in the step 5 may further include: determining the parameters of the ion motion model by adopting a least square nonlinear fitting method, to determine information on structural characteristics of the ions to be measured.

The estimating in the step 5 may further include: extracting an envelope signal from the filtered signal; and finally, determining the parameters of the ion motion model from the extracted envelope signal, to determine information on structural characteristics of the ions to be measured from the determined parameters.

In a second aspect of the present disclosure, a device for analyzing an ion structure, including: a pre-process unit, configured to pre-process a time domain signal of a mirror current of ions to be measured that are obtained from an ion mass analyzer, to obtain a signal to be measured; a spectral peak extraction unit, configured to extract a spectral peak signal of the signal to be measured; a modulation unit, configured to modulate the spectral peak signal, to obtain a modulated signal; a filtering unit, configured to filter the modulated signal, to obtain a filtered signal; and a parameter estimation unit, configured to estimate parameters of an ion motion model with respect to the filtered signal, to determine information on structural characteristics of the ions to be measured from the estimated parameters.

The pre-process unit may be further configured to perform zero-padding and/or enhancement and de-noising on the signal to be measured, so as to pre-process the time domain signal of the mirror current of the ions to be measured.

The spectral peak extraction unit may be further configured to firstly, transform the signal to be measured into a frequency domain by a Fourier transforming; and then, adopt a positioning algorithm, to obtain the spectral peak signal, so as to extract the spectral peak signal of the signal to be measured.

The modulation unit may be further configured to estimate an initial phase ψ*ᵢ of the spectral signal; and then, modulate the spectral peak signal to a low frequency with the estimated phase ψ*ᵢ, obtain the modulated signal, so as to modulate the spectral peak signal.

Moreover, the modulation unit may be further configured to randomly select two initial phases φ₁ and φ₂, and modulate the spectral peak signal with the random selected initial phases φ₁ and φ₂, and extracts a low frequency signal from the spectral peak signal by a low-pass filtering; then, solve a quotient K through an equation

$$\frac{cos ( {ψ}_{i} - {ϕ}_{1} )}{cos ( {ψ}_{i} - {ϕ}_{2} )} = K ;$$

and finally, solve an equation

$${ψ}_{i}^{*} = arc tan ( - \frac{cos {ϕ}_{1} - K cos {ϕ}_{2}}{sin {ϕ}_{1} - K sin {ϕ}_{2}} ) ,$$

to obtain the estimated initial phase ψ*ᵢ, to as to modulate the spectral peak signal.

The modulation unit may be further configured to modulate the spectral peak signal to an intermediate frequency, to obtain the modulated signal, so as to modulate the spectral peak signal.

The filtering unit may be further configured to filter the modulated signal by an n-order m-layer filter and a normalized cutoff frequency of 0.01˜0.03, wherein n is 300-800 and m≧3; and de-sample the signal after each order of the filterings, to adjust the range of the signal, so as filter the modulated signal.

The filtering unit may be further configured to, before the filtering unit filters the modulated signal to obtain a filtered signal, extend the modulated signal, and if a point length of the extension is Num, and a number of orders of the filter is Order, then Num≧½Order+1.

The filtering unit may be further configured to filter the modulated signal by an n-order m-layer filter and a normalized cutoff frequency of 0.01˜0.03, wherein n is 300-800 and m≧3; and de-sample the signal after each order of the filterings, to adjust the range of the signal, so as to filter the modulated signal.

The parameter estimation unit may be further configured to determine the parameters of the ion motion model by a least square nonlinear fitting method, to determine information on structural characteristics of the ions to be measured, so as to estimate the parameters of the ion motion model with respect to the filtered signal.

The parameter estimation unit may be further configured to extract an envelope signal from the filtered signal; and finally, determine the parameters of an ion motion model from the extracted envelope signal, to determine information on structural characteristics of the ions to be measured from the determined parameters, so as to estimate the parameters of the ion motion model with respect to the filtered signal.

According to the device and the method for analyzing an ion structure of the present disclosure, the ion structures may be analyzed by directly analyzing the time domain signal of the mirror current of the ion, thereby the facility cost will be significantly saved.

### BRIEF DESCRIPTION OF THE DRAWINGS

The accompanying drawings are provided for a better understanding of the present disclosure and for illustrating embodiments of the present disclosure, which, together with the description, serves to explain the principle of the present disclosure. In the accompanying drawings

FIG. 1 is a flowchart illustrating a method for analyzing an ion structure according to a first embodiment of the present disclosure;

FIG. 2 illustrates a signal spectrum obtained after a fast Fourier transform (EFT) when the method for analyzing an ion structure according to the first embodiment of the present disclosure is adopted to analyze macromolecular protein of Ubiquitin;

FIG. 3 is a signal flow graph illustrating a filtering and de-sampling in the first embodiment of the present disclosure;

FIG. 4 is a flowchart illustrating a method for analyzing an ion structure according to a second embodiment of the present disclosure;

FIG. 5 is a signal flow graph illustrating a filtering and de-sampling in the second embodiment of the present disclosure;

FIG. 5 is a block diagram illustrating a device for analyzing an ion structure according to a third and a fourth embodiment of the present disclosure.

The reference numbers are as follows:

ST—a time domain signal

SPT—a signal to be measured.

Speak—a spectral peak signal

S_modulation—a modulated signal

SFT—a filtered signal

600—a device for analyzing an ion structure

601—a pre-processing unit

602—a spectral peak extraction unit

603—a modulation unit

604—a filtering unit

605—a parameter estimation unit

### DETAILED DESCRIPTION OF THE INVENTION

Hereinafter, specific embodiments of the present disclosure are described in detail with reference to the accompany drawings. It should be understood that the specific embodiments are merely illustrative examples, and should not be interpreted as limitations to the present disclosure.

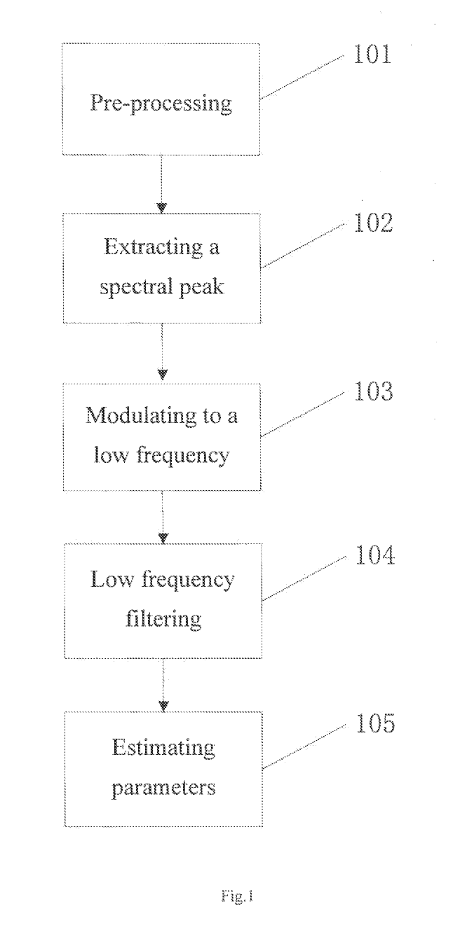

As illustrated in FIG. 1, a method for analyzing an ion structure according to a first embodiment of the present disclosure includes the following steps.

At step 101, a time domain signal ST of a mirror current of ions to be measured that are obtained from an ion mass analyzer is pre-processed, to obtain a signal SPT to be measured. The ion mass analyzer may be a conventional Fourier transform analyzer such as a FT-ICR, are Orbitrap and a Quadrupole Ion Trap, etc., and typically have a sampling frequency range of 500 KHz˜10 MHz and a sampling duration range of 0˜1 minute. Here, the pre-processing of the signal ST may include zero-padding and/or enhancement and de-noising. The zero-padding may be performed by adopting a method described in “A versatile method of discrete convolution and FFT (DC-FFT) for contact analyses” (pages 101-111, issues 1-2, volume 243, Wear, Aug. 28, 2000) of Shuangbiao Liu, Qian Wang and Geng Liu. Generally a one or two times zero-padding is performed on the signal ST. Generally the enhancement and de-noising of the signal may be realized by processing a spectrum of the signal, for example, by estimating a base line of a noise to reduce or eliminate the noise.

Taking analysis of macromolecular protein of Ubiquitin for example, firstly, a time domain signal ST of a mirror current of the macromolecular protein of the substance Ubiquitin is obtained from a FT-ICR Fourier transform analyzer. A sampling frequency adopted for the FT-ICR Fourier transform analyzer is 1.3699e+06 Hzm, and a sampling duration is 6.1237 s. The signal ST is then zero-padded at its tail by two times of its point length, to obtain a signal SPT to be measured.

At step 102, a spectral peak signal Speak of the signal SPT to be measured is extracted. Firstly, the signal SPT is transformed into a frequency domain by a Fourier transform, to obtain power spectrum information of different characteristic frequencies. Then, a positioning algorithm is adopted to determine the frequency information of the spectral peak. For example, a fast Fourier transform (FFT) may be adopted to transform the signal SPT to be measured into the frequency domain, specifically as follows:

Assuming that x(n) is a finite sequence with a length M, a N-point discrete Fourier transform of x(n) may be expressed as an equation (1):

$$X ( k ) = DFT [ x ( n ) ] = {\sum }_{n = 0}^{N - 1} x ( n ) • {W}_{N}^{kn} , \\ k = 0 , 1 , … , N - 1 \\ wherein , \\ {W}_{N} = {e}^{- j \frac{2 π}{N}} . \qquad ( 1 )$$

Specifically, the positioning algorithm at step 102 is, firstly, an initial value and a threshold value is selected, then frequency information and amplitude information of data points with values larger than the threshold value are searched and recorded by cycle comparison, thereby the spectral peak signal Speak with the Maximum value may be found.

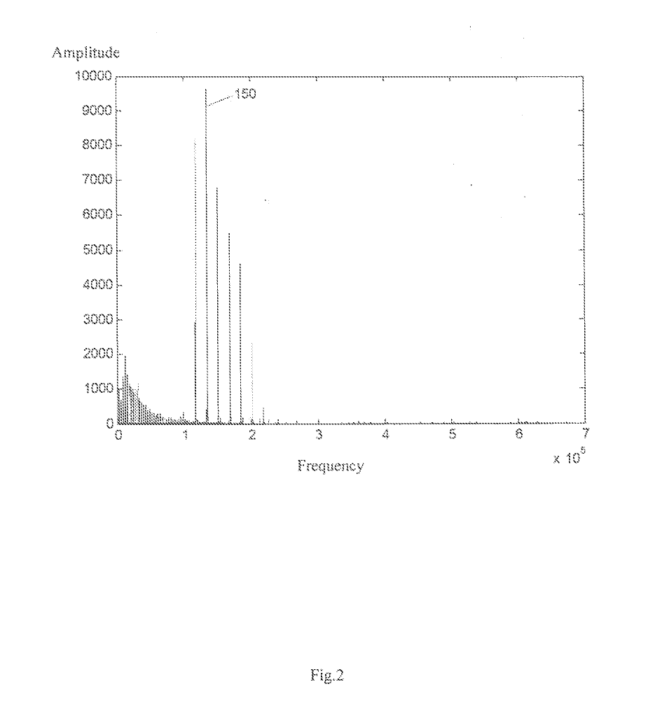

Still taking the macromolecular protein of Ubiquitin for example, firstly the signal SPT to be measured is transformed into a frequency domain by the fast Fourier transform (FFT), to obtain power spectrum information of different characteristic frequencies. FIG. 2 shows respective spectral peaks. Then, position information (corresponding frequency value) and specific amplitude information of each spectral peak are determined. For example, a No.150 spectral peak is found to be the spectral peak with the maximum value, i.e. indicated by Speak, through the positioning algorithm.

As shown in FIG. 1, at step 103, the obtained spectral peak signal Speak is modulated, to obtain the modulated signal S_modulation. The specific process is as follows.

The spectral peak signal Speak may be expressed as the following equation (2):

Speak=fᵢ(t)cos(wᵢt+ψᵢ) (2)

Wherein, fᵢ(t) is a smooth signal with a low frequency. Then, ψᵢ in the equation (2) is solved by a differential phase estimation method, specifically as follows.

Firstly, different initial phases φ₁ and φ₂ are selected randomly, a quotient of both the mathematic estimations is obtained through an equation (3):

$$\frac{cos ( {ψ}_{i} - {ϕ}_{1} )}{cos ( {ψ}_{i} - {ϕ}_{2} )} = K \qquad ( 3 )$$

The equation (3) may be solved, to obtain an estimation value ψ*ᵢ for the initial phase ψᵢ, that is:

$${ψ}_{i}^{*} = arc tan ( - \frac{cos {ϕ}_{1} - K cos {ϕ}_{2}}{sin {ϕ}_{1} - K sin {ϕ}_{2}} ) \qquad ( 4 )$$

It should be noticed that, in modulation with two random phases, at the last step there requires a low-pass filter to extract a signal of a low frequency component. Only by such division, will an equation containing only an unknown parameter be obtained.

Since there involves a division operation finally, a prerequisite is that the denominator shall not be zero, so as to ensure the solution is accurate. Considering an error of calculation, a small number of singular points are tolerable. In order to avoid singular points, the quotient value K is obtained by a fitting estimation.

The specific process is as follows.

The spectral peak signal Speak may be expressed by the above equation (2), wherein the initial phase is ψᵢ.

The spectral peak signal Speak is modulated by adopting cos(wᵢt+φ₁) and cos(wᵢt+φ₂) respectively, then the results are low-passed, and finally perform a division, so as to obtain the equation of the initial phase ψᵢ. The mathematic derivation is as follows.

The spectral peak signal Speak is modulated by adopting cos(wᵢt+φ₁), obtain:

fᵢ(t)cos(wᵢt+ψᵢ)cos(wᵢt+φ₁)=½fᵢ(t)[cos(ψᵢ−φ₁)+cos(wᵢt+ψᵢ+φ₁)]

The result is low-passed, to obtain: ½fᵢ(t)cos(ψᵢ−φ₁)

The spectral peak signal Speak is modulated by cos(wᵢt+φ₂), to obtain:

fᵢ(t)cos(wᵢt+ψ₁)cos(wᵢt+φ₂)=½fᵢ(t)[cos(ψᵢ−φ₂)÷cos(wᵢt+ψᵢ+φ₂)]

The result is low-passed, to obtain: ½fᵢ(t)cos(ψᵢ−φ₂)

After the estimation value ψ*ᵢ for the ψᵢ is obtained as the above described, the low frequency modulation signal S_modulation of the spectral peak signal Speak is obtained as shown by an equation (5):

S_modulation=fᵢ(t)cos(wᵢt+ψ₁)cos(wᵢt+ψ*ᵢ) (5)

In the above example of analysis of the macromolecular protein of Ubiquitin, for example, fᵢ(t) in the equation (2) is a Cauchy model:

$${f}_{i} ( t ) = \frac{{a}_{i}}{1 + {b}_{i} t}$$

ψᵢ in the equation (2) is solved by a differential phase estimation method. Firstly, different initial phases φ₁ and φ₂ are selected randomly, for example, φ₁ and φ₂ are selected as

$$\frac{π}{3} and \frac{π}{6} ,$$

and a quotient of both the mathematic estimations is obtained as follows:

$$\frac{cos ( {ψ}_{i} - \frac{π}{3} )}{cos ( {ψ}_{i} - \frac{π}{6} )} = K$$

The equation may be solved, to obtain an estimation value of the initial phases:

$${ψ}_{i}^{*} = arc tan ( - \frac{cos \frac{π}{3} - K cos \frac{π}{6}}{sin \frac{π}{3} - K sin \frac{π}{6}} )$$

It should be noticed that, in modulation with two random phases, at the last step there requires a low-pass filter to extract a signal of a low frequency component. Only by such division, will an equation containing only an unknown parameter be obtained. The resulted ψ*ᵢ is an estimation of the initial phase ψᵢ.

The specific process is as follows.

The signal Speak in the equation (2) is modulated by

$$cos ( {w}_{i} t + \frac{π}{3} ) and cos ( {w}_{i} t + \frac{π}{6} )$$

respectively. Then the results are low-passed, and finally perform a division, so as to obtain the equation of the initial phase ψᵢ. The mathematic derivation is as follows.

The signal Speak is modulated by

$$cos ( {w}_{i} t + \frac{π}{3} ) ,$$

to obtain

$${f}_{i} ( t ) cos ( {w}_{i} t + {ψ}_{i} ) cos ( {w}_{i} t + \frac{π}{3} ) = \frac{1}{2} {f}_{i} ( t ) [ cos ( {ψ}_{i} - \frac{π}{3} ) + cos ( {w}_{i} t + {ψ}_{i} + \frac{π}{3} ) ]$$

The result is low-passed, to obtain:

$$\frac{1}{2} {f}_{i} ( t ) cos ( {ψ}_{i} - \frac{π}{3} ) .$$

The signal Speak is modulated by

$$cos ( {w}_{i} t + \frac{π}{6} ) ,$$

$${f}_{i} ( t ) cos ( {w}_{i} t + {ψ}_{i} ) cos ( {w}_{i} t + \frac{π}{6} ) = \frac{1}{2} {f}_{i} ( t ) [ cos ( {ψ}_{i} - \frac{π}{6} ) + cos ( {w}_{i} t + {ψ}_{i} + \frac{π}{6} ) ]$$

The result is low-passed, to obtain:

$$\frac{1}{2} {f}_{i} ( t ) cos ( {ψ}_{i} - \frac{π}{6} )$$

Then, the estimation ψ*ᵢ of the initial phase ψᵢ is substituted into the equation (5), to derive the low frequency modulation signal S_modulation of the spectral peak signal Speak.

Turning back to step 104 of FIG. 1. In this step, the above low frequency modulated signal S_modulation is filtered, to obtain the filtered signal SFT.

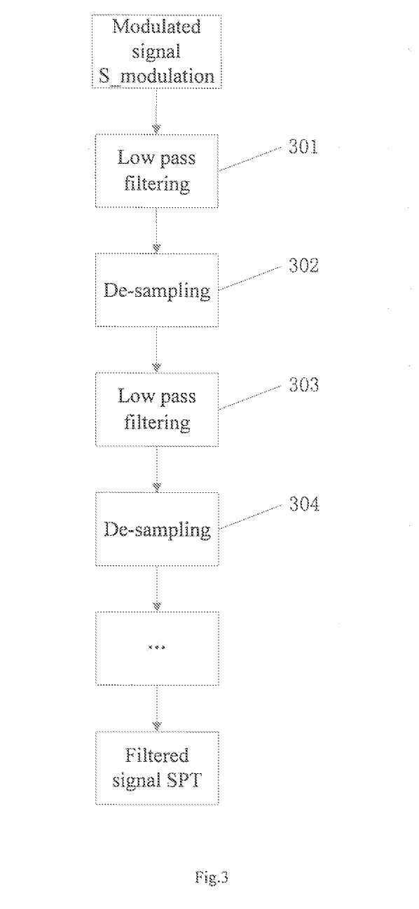

For example, an n-order m-layer filter may be adopted to filter the modulated signal, where n is 300-800, m≧3, and a normalized cutoff frequency is of 0.01˜0.03. After each filtering is completed, the signal may be de-sampled, to adjust the range of the signal. The flow of the signal is shown in FIG. 3, in which the modulated signal S_modulation is subjected to low-pass filtering 301, de-sampling 302, low-pass filtering 303, de-sampling 304 and several cycles (indicated by an ellipsis) of the low-pass filtering 303 and de-sampling 304, to obtain the filtered signal SPT.

The filtering step may be expressed as the following equation (6):

low-pass-filter {fᵢ(t)cos(wᵢt+ψᵢ)cos(wᵢt+ψ*ᵢ)}=low-pass-filter{½fᵢ(t)[cos(ψᵢ−ψ*ᵢ)+cos(wᵢt+ψᵢ+ψ*ᵢ)]}=½fᵢ(t) (6)

It should be noticed that, since a MS ion signal is of a finite length, a boundary effect may be generated during the filtering. Thus, in the design of the filter, the signal may be extended, to increase the number of points of the signal. The commonly adopted methods to extend the signal are: symmetric extension, cycle extension, mirror extension and constant extension. The symmetric extension is to supplement data according to a symmetric axis which is from a starting point of the time axis to a tail point of the time axis. The cycle extension is to take the original signal as a cycle, to extend the signal over the whole time axis by the cycles, so as to finally supplement data of the starting point of time and of the tail point of time. The mirror extension and the constant extension follow a similar principle. Assuming that the extended length of points of front and back is Num, and the number of orders of the filter bank is Order, the extended length of points and the orders of the filter bank have a relationship expressed as the following equation (7).

Num≧½Order+1 (7)

In the above example of analyzing the macromolecular protein of Ubiquitin, for example, a 500-order filter bank with a cutoff frequency (normalized cutoff frequency) of 0.01 and with three layers of filters is adopted. The length of points of front and back by the mirror extension is Num=501, and the number of orders of the filter hank is Order=500, so the above equation (7) is satisfied. After each filtering is completed, the signal is sampled once at a 25-point interval, to adjust the range of the signal. The number of orders of the filters in the first two times of the filterings and the frequency point of −6 db attenuation are fixed. The signal after the second filtering and a de-sampling enters into the third filtering. The number of orders for the third filtering is the same as that of the first two filterings, while the frequency point of −6 db attenuation is calculated from a set brand width of a target signal, and the calculation process is as follows.

Assuming that an effective brand width of the target signal is FinalLowpass, a ration of the frequency of the target signal to the whole frequency brand is:

$$ratio = \frac{FinalLowpass}{fs} \qquad ( 8 )$$

Meantime, the ratio satisfies an equation (9):

ratio=wₙ₁wₙ₂wₙ₃ (9)

Thereby the frequency point of −6 db attenuation of the third layer of filters is finally determined as wₙ₃.

In step 105 of FIG. 1, parameters of an ion motion model fᵢ(t) are estimated with respect to the filtered signal SFT, so as to determine information on structural characteristics of the ions to be measured from the estimated parameters.

According to Shenheng Guan a, Guo-Zhong Li b and Alan G. Marshall a “Effect of ion-neutral collision mechanism on the trapped-ion equation of motion: a new mass spectral line shape for high-mass trapped ions” (Internationa Journal of Mass Spectrometry and Ion Processes 167/168 (1997) 185-193), fᵢ(i) may be an ion motion model equation of a hard sphere model, an ion-molecule collision, an ion-ion collision or a mixture of several types of motion models, and may be specifically determined according to practical experimental conditions.

A fitting algorithm adopted in estimating the parameters in step 105 may be, for example, a nonlinear fitting based on the least square method. After a type of mode of the motion signal of the ions is determined, the optimal parameters in the corresponding ion motion model are obtained based on, for example, the least square sum of error method, thus information on structural characteristics of the ions to be measured may be derived from the estimated parameters.

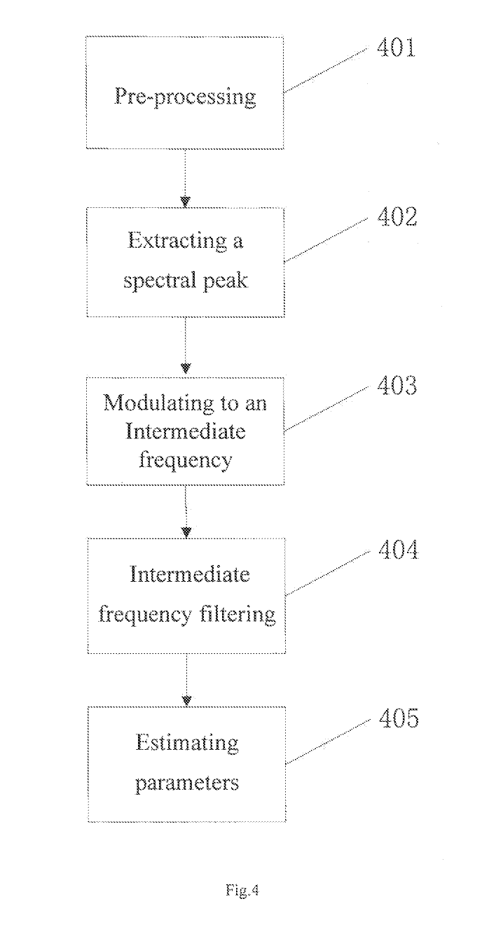

A method for analyzing an ion structure according to the second embodiment of the disclosure is described with reference to FIG. 4. In the first embodiment, the estimation algorithm for the initial phase is actually based on three implied assumptions: \textcircled{1} isomers have the same initial phase; \textcircled{2} phase dispersion effects may be ignored; \textcircled{3} priori information on the initial phase of the substance is obtained in advance. In order to make the algorithm universal, when the possibility of phase dispersion and phase inconsistency exits, an alternative solution according to the second embodiment of the present disclosure may be adopted. Steps 401 and 402 of the method for analyzing an ion structure according to the second embodiment of the present disclosure are the same as the steps 101 and 102 according to the first embodiment, and will not be repeated here.

In step 403 of the method of the second embodiment of FIG. 4, different from the first embodiment, the spectral signal Speak is modulated by an intermediate frequency other than by a low frequency, to obtain the modulated signal S_modulation. In the preferred solution according to the second embodiment, the signal is modulated to an intermediate frequency for the following reasons: \textcircled{1} modulating the signal to an intermediate frequency facilitates the design of the filter; \textcircled{2} compared with modulation to 0 frequency, modulation to an intermediate frequency may extract an envelope of the attenuated signal well enough to eliminate the effect of the initial phase. Therefore, in the second embodiment, instead of estimating the phase, the effect of the phase will be reduced to a negligible level. Instead of modulating the signal to 0 frequency to obtain signal attenuation, the signal is modulated around an intermediate frequency. Then the attenuation trend of the signal will be obtained by extracting the envelope of the signal.

It may be proved by a mathematical derivation that, on one hand, when wᵢ of a signal is large, if wᵢt is much larger than ψᵢ, and cos(wᵢt+ψᵢ)≈cos wᵢt, the effect of the initial phase may be neglected; on the other hand, if cos(wᵢt+ψᵢ)=0, then

$$t = \frac{\frac{π}{2} - {ψ}_{i}}{{w}_{i}} ,$$

which also shows that, when wᵢ is large, the time for compensating a phase lag caused by the initial phase is short, thus, the higher the frequency signal wᵢ carried by the original attenuated signal is, the more possibly the effect of the initial phase may be eliminated.

An intermediate frequency is selected as w_{mid} with respect of the spectral peak Speak expressed by the equation (2), and the signal is modulated by cos w_{mid}, to obtain:

fᵢ(t)cos(wᵢt+ψᵢ)cos w_{mid}t=½fᵢ(t)[cos((wᵢ−w_{mid})t+ψᵢ)+cos(wᵢt+w_{mid}t+ψᵢ)] (10)

The result is low-passed, to obtain:

½fᵢ(t)cos((wᵢ−w_{mid})t+ψᵢ) (11)

Accordingly, in step 404 of the second embodiment, the signal S_modulation modulated by the above intermediate frequency is filtered at the intermediate frequency, so as to obtain a filtered signal SFT.

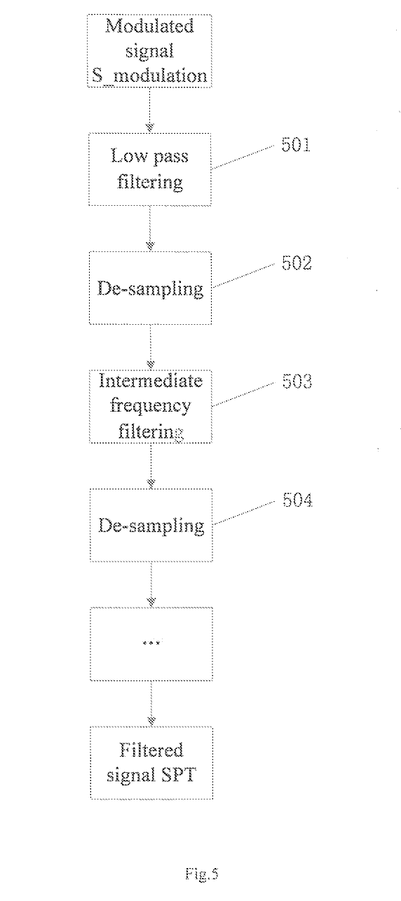

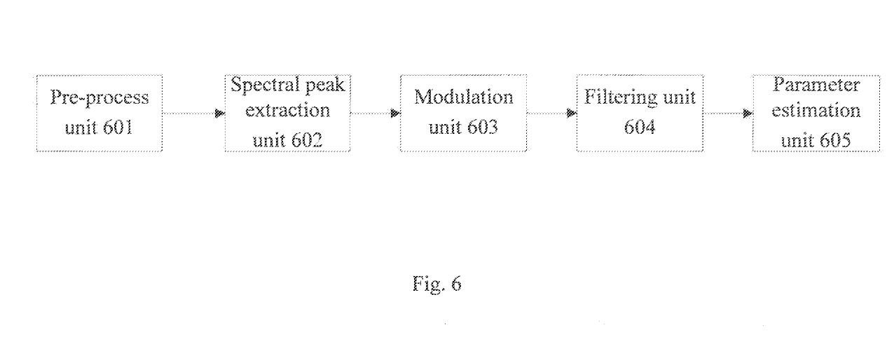

The signal S_modulation modulated by the intermediate frequency may be filtered at the intermediate frequency by, for example, adopting n-order m-layer filters, wherein m is 300-800, m≧3, and a normalized cutoff frequency is of 0.01˜0.1; and the signal after each order of the filtering may be de-sampled, to adjust the range of the signal. The signal flow in step 404 is shown in FIG. 5, in which the modulated signal S_modulation is subjected to low-pass filtering 501, de-sampling 502, intermediate frequency filtering 503, de-sampling 504 and several cycles (indicated by an ellipsis) of intermediate frequency filtering 503 and de-sampling 504, to obtain the filtered signal SPT. Different from FIG. 3, except that the first order is a low-pass filtering, other orders are all intermediate frequency filterings.

As shown in FIG. 4, in step 405 of the second embodiment, an envelope signal is extracted from the above filtered and de-sampled signal by, for example, firstly adopting a nonlinear fitting algorithm based on the least square method to derive an initial amplitude and an attenuation factor, then, obtaining a maximum point and a minimum point of the signal by the above mentioned positioning algorithm, and finally, supplementing data values by an interpolation method to eventually realize the extraction for the envelope signal. After the envelope signal is extracted, similar to the step 105 of the first embodiment, parameters of an ion motion model fᵢ(t) are determined with respect to the envelope signal, so as to determine information on structural characteristics of the ions to be measured from the estimated parameters.

A device for analyzing an ion structure according to a third embodiment of the present disclosure is described with reference to FIG. 6.

As shown in FIG. 6, the device 600 for analyzing ion structures includes a pre-process unit 601, a spectral peak extraction unit 602, a modulation unit 603, a filtering unit 604 and a parameter estimation unit 605.

The pre-process unit 601 is configured to pre-process a time domain signal of a mirror current of ions to be measured that are obtained from an ion mass analyzer, to obtain a signal to be measured. The pre-process may be zero-padding and/or enhancement and de-noising. The pre-process unit 601 may adopt a FPGA (Field-Programmable Gate Array) circuit or an active filter chip, such as a MAX260 chip together with some additional auxiliary circuits, to realize digital logic filtering.

The spectral peak extraction unit 602 is configured to extract a spectral peak signal of the signal to be measured. Specifically, for example, firstly the signal to be measured is transformed into a frequency domain by a Fourier transforming, and then, a positioning algorithm is adopted, to obtain the spectral peak signal. The spectral peak extraction unit 602 may adopt a special DSP (Digital Signal Processing) chip such as a chip of TMS3206XXX series together with some additional auxiliary circuits.

The modulation unit 603 is configured to estimate an initial phase ψ*ᵢ of the spectral signal, and then modulate the spectral peak signal to a low frequency with the estimated phase ψ*ᵢ, to obtain a modulated signal. Specifically, for example, two initial phases φ₁ and φ₂ are randomly selected, the spectral peak signal is modulated with the random selected initial phases φ₁ and φ₂, and their low frequency signals are extracted by low-pass filterings, and then a quotient K is solved through an equation

$$\frac{cos ( {ψ}_{i} - {ϕ}_{1} )}{cos ( {ψ}_{i} - {ϕ}_{2} )} = K ,$$

and the estimated initial phase ψ*ᵢ is finally obtained by solving an equation

$${ψ}_{i}^{*} = arctan ( - \frac{cos {ϕ}_{1} - K cos {ϕ}_{2}}{sin {ϕ}_{1} - K sin {ϕ}_{2}} )$$

The modulation unit 603 may also adopt a special DSP chip such as a chip of TMS3206XXX series together with some additional auxiliary circuits.

The filtering unit 604 is configured to filter the modulated signal, to obtain a filtered signal. The filtering unit 604 may be, for example, configured to filter the modulated signal by adopting an n-order m-layer filter and a normalized cutoff frequency of 0.01˜0.03, wherein n is 300-800 and m≧3, and the signal after each order of the filterings may be de-sampled. If the modulated signal is extended before the first order of the filterings, and if a point length of the extension is Num, and a number of orders of the filter is Order, then Num≧½Order+1. The filtering unit 604 may also adopt a FPGA circuit or an active filter chip, such as a MAX260 chip together with some additional auxiliary circuits, to realize digital logic filtering.

The parameter estimation unit 605 is configured to estimate parameters of an ion motion model with respect to the filtered signal, to determine information on structural characteristics of the ions to be measured from the estimated parameters. The parameters of the ion motion model equation may be determined by adopting a least square nonlinear fitting method, to determine information on structural characteristics of the ions to be measured. The parameter estimation unit 605 may adopt a FPGA circuit together with a single chip computer, such as an Altera stratix chip together with some additional auxiliary circuits, to realize digital logic calculation.

As shown in FIG. 6, an apparatus for analyzing an ion structure according to the fourth embodiment of the present disclosure also includes a pre-process unit 601, a spectral peak extraction unit 602, a modulation unit 603, a filtering unit 604 and a parameter estimation unit 605.

The pre-process unit 601 and the spectral peak extraction unit 602 are respectively the same as the pre-process unit 601 and the spectral peak extraction unit 602 according to the third embodiment, and the description will not be repeated here.

Similar to the third embodiment, in the fourth embodiment, the modulation unit 603 is also configured to modulate the spectral peak signal, to obtain the modulated signal. The difference is that, the spectral peak signal is modulated into an intermediate frequency.

Accordingly, in the fourth embodiment, the filtering unit 604 which is configured to filter the modulated signal may be for example, configured to filter the modulated signal by adopting an n-order m-layer filter and a normalized cutoff frequency of 0.01˜0.03, wherein n is 300-800 and m≧3, and the signal after each order of the filterings may be de-sampled.

In the fourth embodiment, the parameter estimation unit 605 is also configured to estimate parameters of an ion motion model with respect to the filtered signal, to determine information on structural characteristics of the ions to be measured from the estimated parameters. Here, before the parameters of an ion motion model are estimated, firstly an envelope signal of the signal output from the filtering unit 604 is extracted. The extraction method may be referred to the corresponding steps of the method according to the second embodiment. Finally, the parameters of an ion motion model are determined from the extracted envelope signal, to determine information on structural characteristics of the ions to be measured from the determined parameters.

The present disclosure is based on the following principle. Ions will collide with the carrier gas in a Fourier transform ion trap, which causes the rotating radius of the ions reduced, and it is represented as the mirror induction current generated by the movement of the ions to be reduced with time to form a kind of attenuation. When isomers moves in a Fourier transform ion trap, the collision cross-sectional area will be different due to the different ion structures, so the attenuation of energy in the ion trap will be different, and it may be represented by different attenuation coefficient. Shenheng, Guan a, Guo-Zhong Li b, Alan G. Marshall as proposed in “Effect of ion-neutral collision mechanism on the trapped-ion equation of motion: a new mass spectral line shape for high-mass trapped ions” (Internationa Journal of Mass Spectrometry and Ion Processes 167/168 (1997) 185-193) that, for small molecules, the collision model in the mass spectrometer is similar to a L model, and the attenuation mode belongs to an e exponential attenuation; for macromolecules, the collision model is similar to a hard model, and the collision model is similar to a Cauchy distribution, and the like.

Therefore, taking the attenuation mode into consideration, when the damping term associated with the ion collision cross-sectional area in the mass spectral signal is solved out, ions with same charge to mass ratio and different collision cross-sectional area will be recognized by one experiment of the ion mass analyzer. Based on the method and device for analyzing an ion structure according to the present disclosure, the calculation and estimation of the characteristic frequency and attenuation coefficient of the ion to be measured may be realized, so as to distinguish ion particles with different charge to mass ratios, and different types of ions with the same charge to mass ratio, and achieve the purpose of determination of ion structures. Thus, the ion structures may be analyzed by directly analyzing the time domain signal of the mirror current of the ion, thereby the facility cost will be significantly saved.

Other embodiments may be obtained by separating and recombination of the features of each of the above embodiments, which do not depart from the scope of the present disclosure. In addition, it is obvious to those skilled in the art that, various modifications and alterations do not depart from the scope of the present disclosure. Therefore, the present disclosure intends to cover those modifications and alterations to the present disclosure as long as they fall in the scope of the appended claims and their equivalents.

What is claimed is:

1. A method for analyzing an ion structure, comprising the following steps:
step 1, pre-processing a time domain signal of a mirror current of ions to be measured that are obtained from an ion mass analyzer, to obtain a signal to be measured;
step 2, extracting a spectral peak signal of the signal to be measured;
step 3, modulating the spectral peak signal, to obtain a modulated signal;
step 4, filtering the modulated signal, to obtain a filtered signal;
step 5, estimating parameters of an ion motion model with respect to the filtered signal, to determine information on structural characteristics of the ions to be measured from the estimated parameters.

2. The method according to claim 1, wherein the pre-processing in the step 1 comprises performing zero-padding, and/or enhancement and de-noising on the signal to be measured.

3. The method according to claim 1, wherein the extracting in the step 2 comprises:
firstly, transforming the signal to be measured into a frequency domain by a Fourier transforming; and
then, adopting a positioning algorithm, to obtain the spectral peak signal.

4. The method according to claim 1, wherein the modulating in the step 3 comprises:
estimating an initial phase ψ*ᵢ of the spectral signal; and
then, modulating the spectral peak signal to a low frequency with the estimated phase ψ*ᵢ, to obtain the modulated signal.

5. The method according to claim 4, wherein the estimating an initial phase ψ*ᵢ, comprises:
randomly selecting two initial phases φ₁ and φ₂, and modulating the spectral peak signal with the random selected initial phases φ₁ and φ₂, and extracting a low frequency signal from the spectral peak signal by a low-pass filtering; then, solving a quotient K through an equation
$$\frac{cos ( {ψ}_{i} - {ϕ}_{1} )}{cos ( {ψ}_{i} - {ϕ}_{2} )} = K ,$$
and
finally, solving an equation
$${ψ}_{i}^{*} = arctan ( - \frac{cos {ϕ}_{1} - K cos {ϕ}_{2}}{sin {ϕ}_{1} - K sin {ϕ}_{2}} ) ,$$
to obtain the estimated initial phase ψ*ᵢ.

6. The method according to claim 1, wherein the modulating in the step 3 comprises:
modulating the spectral peak signal to an intermediate frequency, to obtain the modulated signal.

7. The method according to claim 4, wherein the filtering in the step 4 comprises:
filtering the modulated signal by adopting an n-order m-layer filter and a normalized cutoff frequency of 0.01˜0.03. wherein n is 300-800 and m≧3; and
de-sampling the signal after each order of the filterings, to adjust the range of the signal.

8. The method according to claim 7, therein before the step 4, the modulated signal is extended, and if a point length of the extension is Num, and a number of orders of the filter is Order, then Num≧½Order+1.

9. The method according to claim 6, wherein the filtering in the step 4 comprises:
filtering the modulated signal by adopting an n-order m-layer filter and a normalized cutoff frequency of 0.01˜0.03, wherein n is 300-800 and m≧3; and
de-sampling the signal after each order of the filterings, to adjust the range of the signal.

10. The method according to claim 4, wherein the estimating in the step 5 comprises:
determining the parameters of the ion motion model by adopting a least square nonlinear fitting method, to determine information on structural characteristics of the ions to be measured.

11. The method according to claim 6, wherein the estimating in the step 5 comprises:
extracting an envelope signal from the filtered signal; and
finally, determining the parameters of the ion motion model from the extracted envelope signal, to determine information on structural characteristics of the ions to be measured from the determined parameters.

12. A device for analyzing an ion structure, comprising:
a pre-process unit, configured to pre-process a time domain signal of a mirror current of ions to be measured that are obtained from an ion mass analyzer, to obtain a signal to be measured;
a spectral peak extraction unit, configured to extract a spectral peak signal of the signal to be measured;
a modulation unit, configured to modulate the spectral peak signal, to obtain a modulated signal;
a filtering unit, configured to filter the modulated signal, to obtain a filtered signal; and
a parameter estimation unit, configured to estimate parameters of an ion motion model with respect to the filtered signal, to determine information on structural characteristics of the ions to be measured from the estimated parameters.

13. The device according to claim 12, wherein the pre-process unit is further configured to perform zero-padding and/or enhancement and de-noising on the signal to be measured, so as to pre-process the time domain signal of the mirror current of the ions to be measured.

14. The device according to claim 12, wherein the spectral peak extraction unit is further configured to
firstly, transform the signal to be measured into a frequency domain by a Fourier transforming; and
then, adopt a positioning algorithm, to obtain the spectral peak signal, so as to extract the spectral peak signal of the signal to be measured.

15. The device according to claim 12, wherein the modulation unit is further configured to
estimate an initial phase ψ*ᵢ of the spectral signal; and
then, modulate the spectral peak signal to a low frequency with the estimated phase ψ*ᵢ, to obtain the modulated signal, so as to modulate the spectral peak signal.

16. The device according to claim 15, wherein the modulation unit is further configured to
randomly select two initial phases φ₁ and φ₂, and modulate the spectral peak signal with the random selected initial phases φ₁ and φ₂, extracts a low frequency signal from the spectral peak signal by a low-pass filtering;
then, solve a quotient K through an equation
$$\frac{cos ( {ψ}_{i} - {ϕ}_{1} )}{cos ( {ψ}_{i} - {ϕ}_{2} )} = K ;$$
and
finally, solve an equation
$${ψ}_{i}^{*} = arctan ( - \frac{cos {ϕ}_{1} - K cos {ϕ}_{2}}{sin {ϕ}_{1} - K sin {ϕ}_{2}} ) ,$$
to obtain the estimated initial phase ψ*ᵢ, so as to estimate the initial phase ψ*ᵢ of the spectral signal,

17. The device according to claim 12, wherein the modulation unit is further configured to modulate the spectral peak signal to an intermediate frequency to obtain the modulated signal, so as to modulate the spectral peak signal.

18. The device according to claim 15, wherein the filtering unit is further configured to
filter the modulated signal b n-order m-layer filter and a normalized cutoff frequency of 0.01˜0.03, wherein n is 300-800 and m≧3; and
de-sample the signal after each order of the filterings, to adjust the range of the signal, so filter the modulated signal.

19. The device according to claim 18, wherein the filtering unit is further configured to, before the filtering unit filters the modulated signal to obtain a filtered signal, extend the modulated signal, and if a point length of the extension is Num, and a number of orders of the filter is Order, then Num≧½Order+1.

20. The device according to claim 17, wherein the filtering unit is further configured to
filter the modulated signal by an n-order m-layer filter and a normalized cutoff frequency of 0.01˜0.03, wherein n is 300-800 and m≧3; and
de-sample the signal after each order of the filterings, to adjust the range of the signal, so as to filter the modulated signal.

21. The device according to claim 15, wherein the parameter estimation unit is further configured to determine the parameters of the ion motion model by a least square nonlinear fitting method, to determine information on structural characteristics of the ions to be measured, so as to estimate the parameters of the ion motion model with respect to the filtered signal.

22. The device according to claim 17, herein the parameter estimation unit is further configured to
extract an envelope signal from the filtered signal; and
finally, determine the parameters of the ion motion model from the extracted envelope signal, to determine information on structural characteristics of the ions to be measured from the determined parameters, so as to estimate the parameters of the ion motion model with respect to the filtered signal.
